(19) United States
(12) Patent Application Publication
(10) Pub. No.: US 2011/0242503 A1
(43) Pub. Date: Oct. 6, 2011

(54) Projection Device and Projection Light Source Control Method Thereof

(76) Inventors: CHEN-KANG SU, Hsichih (TW); HSIN-YU CHEN, Hsichih (TW)

(21) Appl. No.: 12/861,889

(22) Filed: Aug. 24, 2010

(30) Foreign Application Priority Data
Mar. 31, 2010 (TW) 099109913

(51) Int. Cl. G03B 21/14

(52) U.S. Cl. 353/85; 353/121

(57) ABSTRACT

A projection device and a projection light source control method thereof are disclosed. The project device comprises a signal detection module, a projector lamp, and a lamp driver module. The signal detection module is for determining whether an image signal is inputted, executing the normal mode upon determination of the image signal, and executing the power saving mode upon determination of no image signal. The projector lamp is used for emitting a projection light source. The lamp driver module is used for controlling an input voltage inputted to the project lamp. When the power saving mode is executed, the lamp driver module is used for controlling the input voltage to decrease the brightness of the projector lamp and controlling the brightness of the projector lamp to generate a fade-in brightness and a fade-out brightness periodically cycling between a minimum is brightness setting and a maximum brightness setting.

### BACKGROUND OF THE INVENTION

1. Field of the Invention

The present invention relates to a projection device and a projection light source controlling method thereof and, more particularly, to a projection device and a projection light source controlling method thereof capable of controlling an input voltage.

2. Description of the Related Art

With developments in technology, the projection device is more and more ubiquitous. In the prior art, the projection device will shut down the projector lamp to save electricity when the image signal is not inputted. However, in a projection device with a high-pressure mercury-vapor (HPMV) lamp, if the lamp is shut down, a re-lighting process must be executed when the lamp re-starts. As a result, the re-lighting process will cost a lot of time.

Please refer to FIG. 1. FIG. 1 is a brightness and time coordinate diagram of a projection device under different modes in the prior art. When the projector lamp is shut down, the brightness of the projector lamp is extinguished completely, which is the first line L1 of FIG. 1. If the power is re-inputted at the time point T1, the projector lamp can not be started immediately.

A lamp power controlling method under the power saving mode is also disclosed in the prior art. When the image signal is not inputted, the projection device decreases the voltage inputted to the projector lamp to reduce the using power, which is the second line L2 of FIG. 1. For example, the voltage inputted to the projector lamp is decreased to 80 percent to reduce the using power by 20 percent. As a result, if the power is re-inputted at the time point T1, the projector lamp will be started immediately. But overmuch power will be consumed when the projection device executes the method of power saving mode mentioned above.

Therefore, it is desirable to provide a projection device and a projection light source controlling method thereof to mitigate and/or obviate the aforementioned problems.

### SUMMARY OF THE INVENTION

A main object of the present invention is to provide a projection device capable of saving power.

Another main object of the present invention is to provide a projection light source controlling method.

In order to achieve the above mentioned objective, the projection device of the present invention comprises a signal detection module, a projector lamp, and a lamp driver module. The signal detection module is used for determining whether an image signal is inputted; executing the normal mode upon determination of the image signal; and executing the power saving mode upon determination of no image signal. The projector lamp is used for generating a projection light source of the projection device. The lamp driver module is used for controlling an input voltage inputted to the project lamp. When the power saving mode is executed, the lamp driver module is used for controlling the input voltage to decrease the brightness of the projector lamp and controlling the brightness of the projector lamp to generate a fade-in brightness and a fade-out brightness periodically cycling between a minimum brightness setting and a maximum brightness setting.

The projection light source controlling method of the present invention comprises the following steps: determining whether an image signal is inputted to the projection device; if yes, executing the normal mode and projecting a projection picture according to the inputted image signal; if no, executing the power saving mode and controlling an input voltage of a projector lamp to decrease the brightness of the projector lamp; and controlling the brightness of the projector lamp to generate a fade-in brightness and a fade-out brightness periodically cycling between a minimum brightness setting and a maximum brightness setting.

Other objects, advantages, and novel features of the invention will become more apparent from the following detailed description when taken in conjunction with the accompanying drawings.

### BRIEF DESCRIPTION OF THE DRAWINGS

FIG. 1 is a brightness and time coordinate diagram of a projection device under different modes in the prior art.

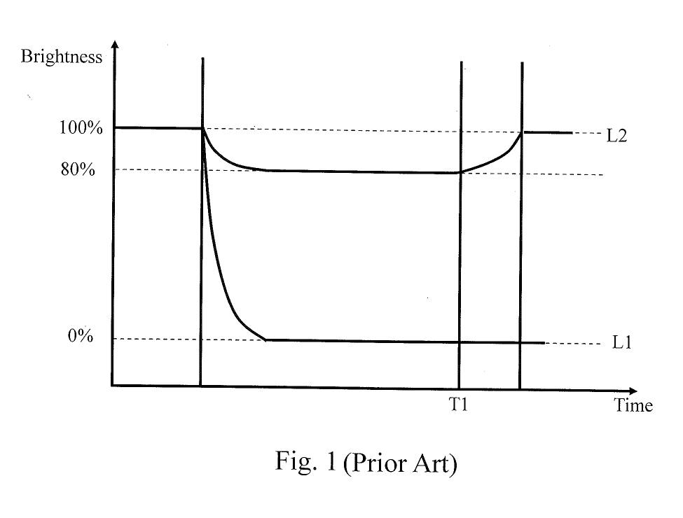

FIG. 2 is a block diagram of a projection device of the present invention.

FIG. 3 is a flow chart of a projection light source controlling method of the present invention.

FIG. 4 is a brightness and time coordinate diagram of a projection device under different modes of the present invention.

### DETAILED DESCRIPTION OF THE PREFERRED EMBODIMENT

The advantages and innovative features of the invention will become more apparent from the following descriptions of the preferred embodiments.

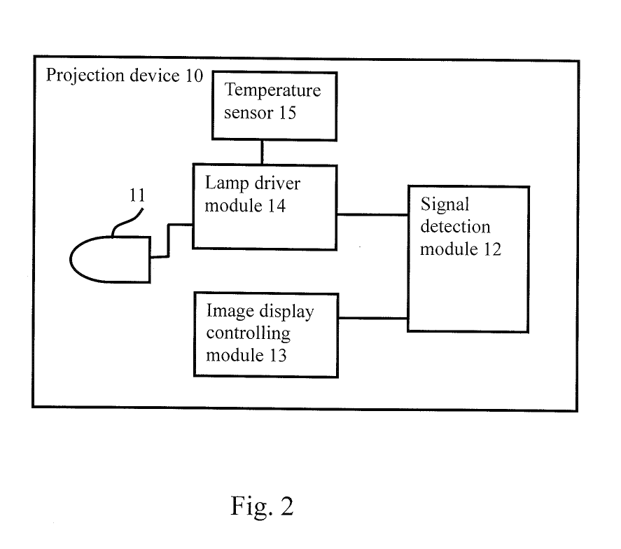

Please refer to FIG. 2. FIG. 2 is a block diagram of a projection device of the present invention.

The projection device 10 of the present invention is used for generating a projection light source by a projector lamp 11, wherein the projector lamp 11 is a high-pressure mercury-vapor (HPMV) lamp. The projection device 10 has at least one normal mode and one power mode and is capable of executing different states. The projection device 10 comprises a projector lamp 11, a signal detection module 12, an image display controlling module 13, a lamp driver module 14, and a temperature sensor 15. Because the projection device 10 with the projector lamp 11 is common nowadays, no more description is provided.

The signal detection module 12 can be a micro controller unit (MCU) and is used for determining whether an image signal is inputted to the projection device 10. The signal detection module 12 generates a corresponding control signal to control the projection device 10 to execute the normal mode upon determination of the image signal and generates another corresponding control signal to control the projection device 10 to execute the power saving mode upon determination of no image signal.

The image display controlling module 13 is used for projecting a projection picture in the normal mode. If the power saving mode is executed, the image display controlling module 13 is used for shutting down the projection picture to save the power. Because the technology of projecting the image is common nowadays, no more description is provided.

The lamp driver module 14 is used for deciding the input voltage inputted to the projector lamp 11 to control the brightness of the projector lamp 11. Furthermore, the lamp driver module 14 is capable of controlling the brightness of the projector lamp 11 by adjusting an input current. The present invention is not limited only to the abovementioned method. When the normal mode is executed, the brightness of the projector lamp 11 is controlled to the normal brightness and the input voltage of the projector lamp 11 is at a normal value. When the power saving mode is executed, the lamp driver module 14 decreases the input voltage which is inputted to the projector lamp 11 to reduce the brightness of the projector lamp 11. Furthermore, the lamp driver module 14 is used for controlling the input voltage to decrease the brightness of the projector lamp 11 and for controlling the brightness of the projector lamp 11 to generate a fade-in brightness and a fade-out brightness periodically cycling between a minimum brightness setting and a maximum brightness setting.

Take note that the minimum brightness setting is the minimum brightness of an arc of the projector lamp 11. In order to keep the arc of the projector lamp 11 at minimum brightness and not extinguished, the projector lamp 11 has to be maintained above a minimum temperature. Therefore, the projection device 10 of the present invention further comprises a temperature sensor 15 used for detecting the temperature to of the projector lamp 11. Furthermore, the temperature sensor 15 electrically connects to the lamp driver module 14 to control the projector lamp 11 to increase the temperature when the temperature of the projector lamp 11 is reduced to the minimum temperature. The input voltage of the projector lamp 11 is increased to increase the brightness of the projector lamp 11 to the maximum brightness progressively. Because projector lamps 11 of different Wattage might have different minimum brightness settings or minimum temperature, the minimum brightness setting of the present embodiment is set as 20 percent of the normal brightness of the projector lamp 11, or the brightness to which the minimum temperature corresponds, but the present invention is not limited to the brightness abovementioned. Furthermore, the maximum brightness setting can be the normal brightness or 80 percent of the normal brightness of the projector lamp 11.

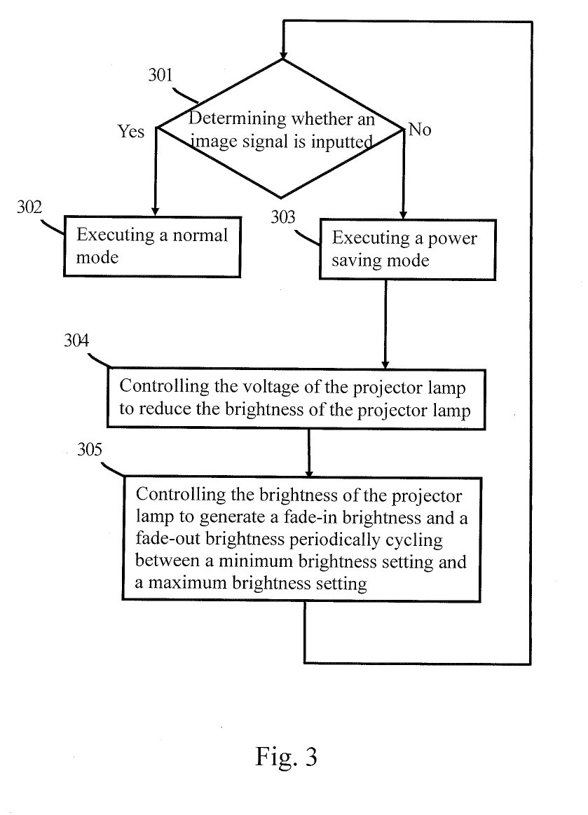

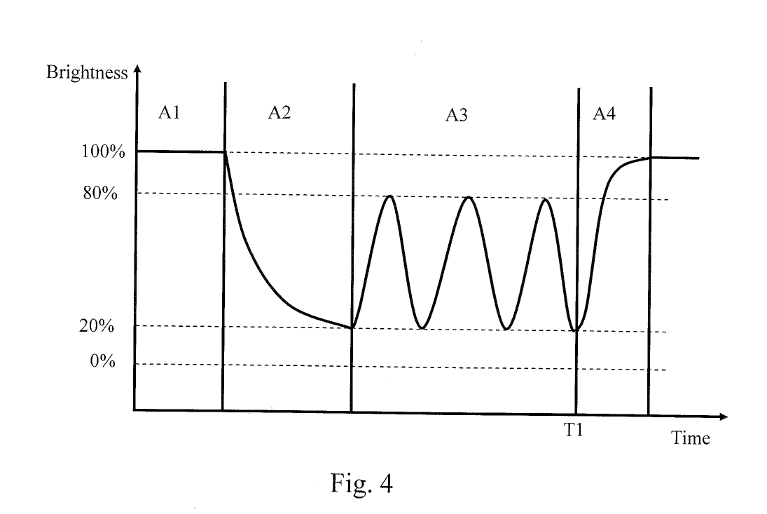

Please refer to FIG. 3 and FIG. 4, wherein FIG. 3 is a flow chart of a projection light source controlling method of the present invention and FIG. 4 is a brightness and time coordinate diagram of a projection device under different modes of the present invention.

Take note that although the projection light source controlling method is illustrated using the projection device 10, the projection light source controlling method is by no means restricted to usage only with the projection device 10.

First, step 301 is performed: determining whether an image signal is inputted.

When the projection device 10 is started, the signal detection module 12 is used for determining whether an image signal is inputted.

If yes, then step 302 is performed: executing a normal mode.

If the image signal is inputted, the projection device 10 executes the normal mode to control the image display controlling module 13 projecting a projection picture. Concurrently, the lamp driver module 14 controls the input voltage inputted to the projector lamp 11 to maintain the normal brightness. As shown in the time period A1 of FIG. 4, the input voltage of the projector lamp 11 is maintained at 100 percent.

If the image signal is not inputted, step 303 is performed: executing a power saving mode.

When the image signal is not detected by the signal detection module 12, the projection device 10 executes the power saving mode to shut down the image display controlling module 13 and does not display the image signal.

Then step 304 is performed: controlling the voltage of the projector lamp to reduce the brightness of the projector lamp.

The lamp driver module 14 controls the voltage inputted to the projector lamp 11 to reduce the brightness of the projector lamp 11. As s shown in the time period A2 of FIG. 4, the brightness of the projector lamp 11 in the present embodiment is reduced to 20 percent of the normal brightness. Furthermore, the temperature of the projector lamp 11 can also be detected by the temperature sensor 15 to determine whether the temperature of the projector lamp 11 is the minimum temperature in order to maintain the minimum brightness. As a result, the lamp driver module 14 is capable of reducing the temperature of the projector lamp 11 to the minimum temperature in order to maintain the minimum brightness. The present invention is not limited only to the abovementioned method; the method of maintaining the ark of the projector lamp 11 without expulsion is the protection scope of the present invention.

Finally, step 305 is performed: controlling the brightness of the projector lamp to generate a fade-in brightness and a fade-out brightness periodically cycling between a minimum brightness setting and a maximum brightness setting.

Finally, the lamp driver module 14 controls the brightness of the projector lamp 11 to generate a fade-in brightness and a fade-out brightness periodically cycling between a minimum brightness setting (or a minimum temperature which is able to maintain the minimum brightness of the ark of the projector lamp 11) and a maximum brightness setting. As shown in the time period A3 of FIG. 4, the brightness of the projector lamp 11 of the present embodiment is generated as the fade-in brightness and the fade-out brightness periodically cycling between 20 percent of the normal brightness and 80 percent of the normal brightness. The cycle duration above mentioned can be 5 seconds but the present invention is not limited to this duration.

Then step 301 will be performed repeatedly to detect whether the image signal is re-inputted by the signal detection module 12. When the image signal is re-inputted, shown as the time point T1 in FIG. 4, the lamp driver module 14 controls the input voltage of the projector lamp 11 to the normal value, which is the time period A4 of FIG. 4. Then the brightness of the projector lamp 11 recovers to the normal value, i.e., returns to time period A1 without waiting for the projector lamp 11 to execute the re-light mode. As a result, a great amount of time will be saved.

Take note that the steps of the projection light source controlling method are not restricted to the abovementioned sequence. The order of the steps can be modified as long as the objectives of the invention are attained.

By the method and the device abovementioned, the power saving mode of the present invention is capable of saving more electric power than the power saving mode of the prior art. Furthermore, the normal mode can be executed immediately after the image signal is inputted. Therefore, the aforementioned problems of the prior art can be mitigated.

Although the present invention has been explained in relation to its preferred embodiment, it is to be understood that many other possible modifications and variations can be made without departing from the spirit and scope of the invention as hereinafter claimed.

What is claimed is:

1. A projection device having at least one normal mode and one power saving mode, the projection device comprising:
a signal detection module for determining whether an image signal is inputted; executing the normal mode upon determination of the image signal; and executing the power saving mode upon determination of no image signal;
a projector lamp for generating a projection light source of the projection device; and
a lamp driver module for controlling an input voltage inputted to the project lamp;
wherein when the power saving mode is executed, the lamp driver module is used for controlling the input voltage to decrease the brightness of the projector lamp and for controlling the brightness of the projector lamp to generate a fade-in brightness and a fade-out brightness periodically cycling between a minimum brightness setting to a maximum brightness setting.

2. The projection device as claimed in claim 1, further comprising an image display controlling module; if the normal mode is executed, the image display controlling module projects a projection picture according to the image signal; if the power saving mode is executed, the image display controlling module shuts down the projection picture.

3. The projection device as claimed in claim 1, wherein if the signal detection module detects the image signal under the power saving mode, the normal mode is resumed and the lamp driver module controls the input voltage to resume the normal brightness of the projector lamp.

4. The projection device as claimed in claim 1, wherein the minimum brightness setting is a brightness that an arc can maintain when the temperature of the projector lamp is reduced, and the minimum brightness setting corresponds to a minimum temperature.

5. The projection device as claimed in claim 4, wherein the projection device comprises a temperature sensor for detecting the temperature of the projector lamp to determine whether the temperature of the projector lamp is the minimum temperature.

6. A projection light source controlling method used in a projection device which comprises having at least one normal mode and one power saving mode comprising the following steps:
determining whether an image signal is inputted to the projection device;
if yes, executing the normal mode and projecting a projection picture according to the image signal;
if no, executing the power saving mode and controlling an input voltage of a projector lamp to decrease the brightness of the projector lamp; and
controlling the brightness of the projector lamp to generate a fade-in brightness and a fade-out brightness periodically cycling between a minimum brightness setting and a maximum brightness setting.

7. The projection light source controlling method as claimed in claim 6, the method further comprising:
setting a minimum temperature that an arc can maintain when the temperature of the projector lamp is reduced.

8. The projection light source controlling method as claimed in claim 7, the method further comprising:
detecting the temperature of the projector lamp to determine whether the temperature of the projector lamp is the minimum temperature.

9. A projection light source controlling method used for controlling a brightness of a projector lamp of a projection device comprising the following steps:
determining whether an image signal is inputted to the projection device; and
if no, controlling the brightness of the projector lamp to generate a fade-in brightness and a fade-out brightness periodically cycling between a minimum brightness setting and a maximum brightness setting.

10. A projection device comprising:
a projector lamp used for generating a projection light source;
a signal detection module for determining whether an image signal is inputted and generating a corresponding control signal according to the detection result; and
a lamp driver module electrically connected between the signal detection module and the projector lamp and used for controlling the brightness of the projector lamp after receiving a control signal;
when the signal detection module does not detect the image signal, the lamp driver module controls the brightness of the projector lamp to generate a fade-in brightness and a fade-out brightness periodically cycling between a minimum brightness setting and a maximum brightness setting.
